(19) United States
(12) Patent Application Publication
(10) Pub. No.: US 2019/0037955 A1
(43) Pub. Date: Feb. 7, 2019

(54) A CRASH PROTECTION MODULE FOR WEARABLE ARMOUR

(71) Applicant: FORCITE HELMET SYSTEMS PTY LTD, ALEXANDRIA (AU)

(72) Inventors: Alfred Boyadgis, Earlwood (AU); Julian Chow, Baulkham Hills (AU); Tom Pisko, Chatswood (AU)

(73) Assignee: FORCITE HELMET SYSTEMS PTY LTD, ALEXANDRIA (AU)

(21) Appl. No.: 16/073,971

(22) PCT Filed: Jan. 27, 2017
(86) PCT No.: PCT/AU2017/000010

§ 371 Date: Jul. 30, 2018

(30) Foreign Application Priority Data
Jan. 29, 2016 (AU) 2016900325

(51) Int. Cl. A42B 3/06; A42B 3/12; G03B 17/56

(52) U.S. Cl. CPC A42B 3/062; A42B 3/124; A41D 13/0156; G03B 17/566; G03B 17/561

(57) ABSTRACT

A crash protection module for mounting on wearable armour, the crash protection module including a mounting base adapted to receive an external device, an energy absorbing element on the mounting base, the energy absorbing element configured to compress generally along a longitudinal axis on impact, wherein the energy absorbing element is adapted to be received in a cooperating recess of wearable armour. Wearable armour such as a helmet containing the crash protection module is also disclosed.

### RELATED APPLICATIONS

This application claims the benefit of Australian Provisional Patent Application No 2016900325, filed on 29 Jan. 2016, the disclosures of all of which are hereby expressly incorporated by reference in their entireties.

### TECHNICAL FIELD

The present technology relates to a crash protection element for use with a wearable armour protection system, the latter of which in one embodiment is a helmet system. The present technology is particularly suited to helmets, and in particular helmets with integrated electronics and/or camera modules.

### BACKGROUND

Electronic action-sporting equipment is known today, as is evidenced by products such as the GoPro video recording camera system.

For vantage purposes and the like, users typically mount such cameras and the like to their helmets.

However, anything which mounts to a helmet, from a bracket to a decal, has the potential to reduce the helmet's ability to protect the head on which it is worn from impacts. Mounting of electronic devices and the like to helmets can pose a significant safety risk in that, during the event of an impact, the electronic devices may pierce the helmet and either penetrate the skull of the wearer or expose the skull of the wearer to excessive point force.

Furthermore, the electronic componentry may otherwise weaken the integrity of the helmet by providing excessive point forces (as opposed to an otherwise evenly distributed force) which interferes with the structural integrity of the helmet causing the helmet to break apart.

Electronic componentry can form other hazards, especially where the electronic componentry comprises batteries. In this manner, batteries poses risks such as fire risks such as during an electrical short or the like or chemical burns from corrosive battery chemicals.

The present inventors have developed a wearable armour construction for housing electronic componentry and a modular electronic component for wearable armour.

### SUMMARY

In a broad aspect there is provided a crash protection module adapted to be associated with wearable body armour, the crash protection module being configured to deflect and/or crumple in the event of an impact. The purpose of the crash protection module is so that electronics or other accessory module mounted on the crash protection module and thereby itself associated with the wearable body armour, is inhibited from piercing or deforming an internal wall of the wearable body armour during an impact, and/or is inhibited from increasing impact damage to a user by virtue of its association with the wearable body armour.

In a broad aspect there is provided a module, zone or portion of wearable body armour which increases a surface area over which an impact force spreads against a foam layer during an impact. The module may increase the surface area by utilising fingers against recesses, undulations or waveforms against cooperating recesses formed in foam layer or layering in the wearable body armour.

In an aspect there is provided a crash protection module for mounting on wearable armour, the crash protection module comprising:

a mounting base adapted to receive an external device;

an energy absorbing element on the mounting base, the energy absorbing element configured to compress generally along a longitudinal axis on impact;

wherein the energy absorbing element is adapted to be received in a cooperating recess of wearable armour.

In an embodiment the crash protection module comprises a plurality of energy absorbing elements adapted to be received in a cooperating recesses of the wearable armour.

In an embodiment the mounting base is integral with the energy absorbing element.

In an embodiment the energy absorbing element is cylindrical, square, pentagonal, hexagonal, elliptical, or irregular in cross section.

In an embodiment the external device is integral with the mounting base.

In an embodiment the energy absorbing elements each have a slightly different compressibility to facilitate deflecting of the mounting base in the event of an impact on a portion of the crash protection module.

In an embodiment the energy absorbing element is constructed from a compressible material selected from the group consisting of rubber and expanded polystyrene (EPS).

In an embodiment the energy absorbing element includes one or more voids of a separate material of a different density.

In an embodiment the density of the rubber is between about 500 kg/m³ and 3000 kg/m³.

In an embodiment the density of the EPS is between about 25 kg/m³ and 200 kg/m³.

In an embodiment the energy absorbing element is arranged on the mounting base in a staggered arrangement being evenly spaced from each of their neighbouring energy absorbing elements.

In an embodiment the energy absorbing element is arranged in diagonal rows of three across a rectangular mounting base.

In a further aspect there is provided an article of wearable armour adapted to receive an external device, the amour comprising:

an impact resistant shell;

a cooperating recess in the impact resistant shell adapted to receive an energy absorbing element; and

a crash protection module according to the present technology.

In an embodiment the wearable armour includes an external device attached to the crash protection module.

In an embodiment the external device is selected from the group consisting of light, camera, and phone.

In an embodiment the wearable armour is selected from helmet, glove, boot, shin guard, forearm or upper arm guard, thigh guard, and breastplate.

In an embodiment the helmet is for bicycle riding, skiing, snowboarding, motorcycle riding, or car racing.

In an embodiment the helmet is for bicycle riding.

In an embodiment the crash protection module is flush mounted within the wearable armour.

In a further aspect, there is provided a helmet comprising:

an impact resistant shell;

a crash protection module including a plurality of energy absorbing elements;

cooperating recesses in the impact resistant shell adapted to receive the plurality of energy absorbing elements; and

a camera mounted in the crash protection module.

In an embodiment the crash protection module is flush mounted within the impact resistant shell of the helmet.

Throughout this specification, unless the context clearly requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term ‘consisting of’ means consisting only of.

Any discussion of documents, acts, materials, devices, articles or the like which has been included in the present specification is solely for the purpose of providing a context for the present technology. It is not to be taken as an admission that any or all of these matters form part of the prior art base or were common general knowledge in the field relevant to the present technology as it existed before the priority date of each claim of this specification.

Unless the context requires otherwise or specifically stated to the contrary, integers, steps, or elements of the technology recited herein as singular integers, steps or elements clearly encompass both singular and plural forms of the recited integers, steps or elements.

In the context of the present specification the terms ‘a’ and ‘an’ are used to refer to one or more than one (ie, at least one) of the grammatical object of the article. By way of example, reference to ‘an element’ means one element, or more than one element.

In the context of the present specification the term ‘about’ means that reference to a figure or value is not to be taken as an absolute figure or value, but includes margins of variation above or below the figure or value in line with what a skilled person would understand according to the art, including within typical margins of error or instrument limitation. In other words, use of the term ‘about’ is understood to refer to a range or approximation that a person or skilled in the art would consider to be equivalent to a recited value in the context of achieving the same function or result.

Those skilled in the art will appreciate that the technology described herein is susceptible to variations and modifications other than those specifically described. It is to be understood that the technology includes all such variations and modifications. For the avoidance of doubt, the technology also includes all of the steps, features, and compounds referred to or indicated in this specification, individually or collectively, and any and all combinations of any two or more of said steps, features and compounds.

In order that the present technology may be more clearly understood, preferred embodiments will be described with reference to the following drawings and examples.

### BRIEF DESCRIPTION OF THE DRAWINGS

Notwithstanding any other forms which may fall within the scope of the present invention, to make the technology more clearly understood, an embodiment of the technology will now be described, by way of example only, with reference to the accompanying drawings in which:

FIG. 1 shows an isometric view from above and one side of wearable body armour in the form of a helmet in accordance with an embodiment of the present technology;

FIG. 2 shows a front elevation view of the helmet system in accordance with embodiments of the present technology;

FIG. 3 shows a detail cross-sectional view through A-A in FIG. 2 of the helmet showing a camera module mounted on a crash protection module of the helmet in further detail in accordance with embodiments of the present disclosure;

FIG. 4 shows an underside isometric view of the helmet;

FIG. 5 shows an isometric view from the rear and one side of a compressible element module being part of an embodiment of a crash protection module;

FIG. 6 shows a plan view of the compressible element module;

FIG. 7 shows a rear elevation view of the compressible element module;

FIG. 8 shows a front elevation view of the compressible element module;

FIG. 9 shows a left side elevation view of the compressible element module;

FIG. 10 shows a right side section view through A-A in FIG. 7 of the compressible element module;

FIG. 11 shows an isometric section view through a compressible element module having voids at their bases;

FIG. 12 shows cooperating recesses for receiving the module shown in FIG. 11;

FIG. 13 shows a helmet assembly using the modules shown in FIGS. 11 and 12 in a crash test situation;

FIG. 14 shows a detail section view of the helmet and crash protection module in a situation where a modelled crash is imminent;

FIG. 15 shows the same detail section view as in FIG. 11 but the helmet is part way through a computer-modelled steel anvil impact test, and the Figure is showing certain selected compressible elements of the crash protection module partially compressed and partially deflected;

FIG. 16 shows a final stage of the modelled crash test, which is a rebound after the compressible elements have compressed in the modelled test, wherein the camera is deflected and the crash protection module can be seen not to have distended an inner layer of the helmet or pierced the inner layer of the helmet;

### DETAILED DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

It is to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

In an aspect there is provided a crash protection module for mounting on wearable armour, the crash protection module comprising:

a mounting base adapted to receive an external device;

an energy absorbing element on the mounting base, the energy absorbing element configured to compress generally along a longitudinal axis on impact;

wherein the energy absorbing element is adapted to be received in a cooperating recess of wearable armour.

In a further aspect there is provided an article of wearable armour adapted to receive an external device, the amour comprising:

an impact resistant shell;

a cooperating recess in the impact resistant shell adapted to receive an energy absorbing element; and

a crash protection module according to the present technology.

In a further aspect, there is provided a helmet comprising:

an impact resistant shell;

a crash protection module including a plurality of energy absorbing elements;

cooperating recesses in the impact resistant shell adapted to receive the plurality of energy absorbing elements; and

a camera mounted in the crash protection module.

In accordance with another aspect there is provided a crash protection module for mounting on wearable armour, the crash protection module including:

a deflector element which is associated with the wearable armour such that any impact energy received by the crash protection module is deflected in a direction toward a skin of the wearable armour.

In accordance with another aspect there is provided a crash protection module for mounting on wearable armour, the crash protection module including:

one or more energy absorbing elements mounted on an element mounting base, the or each energy absorbing element including a compressible element, and further configured to compress generally along a longitudinal axis in the event of a crash,

wherein the or each compressible element is adapted to be received in one or more cooperating recesses of a substrate of compressible armour material.

The energy absorbing elements may increase a surface area over which an impact force is spread over a foam element or foam elements mounted in an item of wearable body armour. The energy absorbing elements increase the surface area by being shaped into fingers, waves, undulations, and the fingers, waves, undulations may be received in cooperating recesses in a foam layer and may be formed into major and minor forms.

A general operating principle of embodiments of the present technology is that damage related to impact energy is proportional to the quantity Nm⁻². Therefore increasing the denominator m² reduces the impact or impulse energy received.

In accordance with another aspect there is provided a crash protection module for mounting on wearable armour, the crash protection module including:

one or more compressible elements mounted on the wearable armour so as to deflect during an impact so as to deflect impact forces away from a perpendicular to the wearable armour and toward an axis parallel to a skin of the wearable armour.

The arrangement of the crash protection module is such that during an impact, the crash protection module tends to absorb and deflect impact forces in a direction toward a skin of the wearable armour and into an energy absorbing layer of compressible armour material lined along the skin of the wearable armour.

In one embodiment the base is attached to the or each compressible element for ease of module assembly and for efficient transfer of forces to the base and/or the deflector element. In another embodiment the base is integral with the or each compressible element wherein the base is constructed from the same material as the compressible element for further ease of module assembly and more efficient transfer of forces to the base and/or the deflector element.

In one embodiment the deflector element is integral with one or more of the compressible elements in that the deflector element is an arrangement of compressible elements mounted on a deflecting base, wherein each of the compressible elements has a slightly different compressibility to facilitate deflecting of the deflecting base in the event of an impact on a portion of the crash protection module.

The deflector element may be constructed from a hard plastic or any suitable material and may be a wedge or ramp which is mounted on the element mounting base or the element mounting base itself of course may be a ramped or wedge-shaped deflector element so that it may facilitate deflecting impact forces in the event of an impact.

The deflector element may be ABS, polymer, D30 (impact hardening polyurethane), and equally, the compressible elements may be constructed from these materials or other suitable materials including polymers.

The or each compressible element may be constructed from a suitable compressible material including rubber, expanded polystyrene (EPS), and other suitable materials. The or each compressible element may also include one or more voids of a separate material of a different density such as rubber, expanded polystyrene, air, and the like so as to facilitate deflection and compression without rupturing or distending an inside skin of the wearable armour. The density of the rubber elements is between about 500 kg/m³ and 3000 kg/m³, although, as it will be understood, suitable densities could be 750, 1000, 1250, 1500, 1750, 2000, 2250 and the like, depending on the size of the wearer's head, mass, application, etc. The density of the EPS elements is between about 25 kg/m³ and 200 kg/m³ and for similar reasons the density of the EPS elements could be 40, 50, 55, 60, 65, 70, 75, 80, 85, 90, 110, 125, 150 etc.

The arrangement of compressible elements may be such that the they are mounted on the base in a staggered arrangement, so that they are evenly spaced from each of their neighbouring compressible elements.

Generally speaking, in a prototype arrangement, the compressible elements are roughly arranged in diagonal rows of three across a rectangular base plate, itself arranged on a wedged deflector plate. The camera is mounted on the deflector plate, which faces outward from the user.

The wearable armour may include gloves, boots, shin guards, forearm or upper arm guards, thigh guards, breastplate or any suitable wearable armour. In one particularly suitable embodiment the wearable armour is a helmet for bicycle riding, skiing, snowboarding, motorcycle riding, car racing, or other suitable head protection for sports and other active pursuits.

The arrangement may be such that a skin of the wearable body armour may comprise a plurality of crash protection modules disposed abutting, adjacent or near enough to one another, so as to form a kind of articulated tiled or articulated plate exoskeleton, each tile or plate of which may perform its compressing and/or deflection function in the event of a crash. In that embodiment, the impacted area may be replaced after a crash and then a user may then proceed to keep wearing the wearable body armour. In one advantageous embodiment, one crash protection module forms one portion of the wearable armour at a front portion of a helmet, and on the crash protection module is mounted a camera, the purpose of the crash protection module being to protect the user from the camera impacting their head in an accident.

In one embodiment the energy absorbing elements include fingers which when installed in the wearable body armour extend along a longitudinal axis disposed generally perpendicular to the skin of the wearable body armour. The fingers may be cylindrical, or may be square in cross section, or any other suitable cross section, including pentagonal, hexagonal, elliptical, or some other irregular cross sectional arrangement. The fingers may form a frusto conical shape and/or may be domed at their ends, or pointed or some other suitable arrangement, depending on the compressibility profile and integration desired with the cooperating recesses in the wearable body armour. There may be fins which extend longitudinally from the fingers or other elements.

There may be other arrangements of surface-area increasing elements, such as wavy protrusions, and the wavy protrusions may change in amplitude and frequency to cause a deflection in one selected direction or other. There may be major waves and minor waves on each protrusion. The waves also may have fins protruding from each protrusion and cooperating fin receiving recesses in the foam.

The voids in the energy absorbing elements may be disposed at the base of each finger or arranged at various intervals along the fingers depending on the compressible profiles that are desired.

### Helmet Structure Including Crash Protection Module

In the embodiment that is described below, there will be described a helmet system comprising unique construction, componentry and functionality. In embodiments, and as will be described herein with reference to exemplary applications, the helmet system is primarily adapted for sporting applications, such as extreme sports including mountain biking, downhill skiing, snowboarding and the like.

However, it should be appreciated that the helmet system need not necessarily be limited to this particular application and may be utilised also for applications other than extreme sports, such as by being suited for civilian use such as motorcycle helmets and the like, and medical, police and military use and more.

Referring to the Figures there is shown a helmet system generally indicated at 25. There will now be described various structural aspects of the helmet system 25.

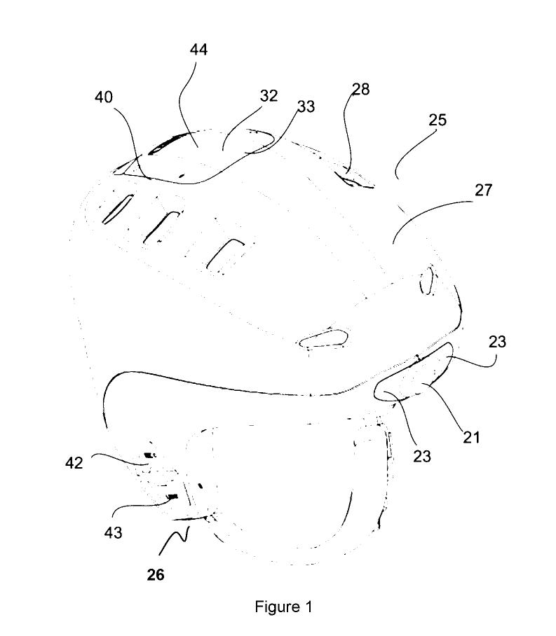

FIG. 1 shows an isometric view from above and one side of a helmet system 25. As is shown in FIG. 1, there is provided a forward mounted camera 21, a camera control module disposed at 32 and a battery module 40 containing a battery 33.

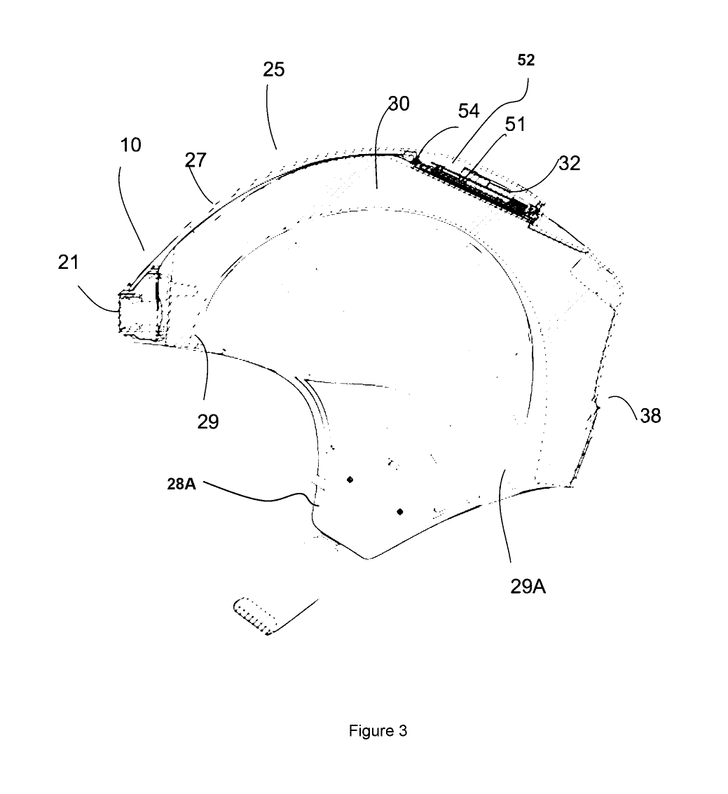

Furthermore, in FIG. 3 there is provided a cross-sectional profile of the padding and some shock absorbing portions of the helmet system 25 which, in an embodiment, comprises outer core 30 and respectively less dense inner padding 29.

Helmet system 25 may further comprise a lining 29A for comfort purposes.

Furthermore, there are provided various air vents 28.

Furthermore, there are provided strap engagements 41 adapted to form a mechanical interlock with appropriate chinstrap mechanical interlock portions during the manufacture process.

Furthermore, there is provided the chinstrap 26A adapted to locate about the chin of the wearer in use.

Furthermore, there are shown appropriate locations of speaker apertures 28A adapted to enhance the audibility of audio signals from an audio player device 24.

FIG. 3 shows a side elevation section view of the helmet system 25. As can be appreciated, the helmet system 25 comprises an open face design with the helmet system 25 covering the head and the ears of the wearer. However, it should be noted that in other embodiments, the helmet system 25 may be configured in other fashions, such as by being fully enclosed including by comprising an active heads up display and the like.

As can be seen from FIG. 3, the helmet system 25 comprises the chinstrap 26A for securement purposes. Furthermore, the helmet system 25 comprises a hardened outer shell 27 preferably in polycarbonate or suitable plastic.

The air vents 28 for ventilation purposes are also shown, the air vents 28 being suited for drawing air flow into the helmet for cooling, as is especially experienced during high-speed downhill events. In embodiments, the air vents 28 may be selectively openable depending on the amount of ventilation required.

The helmet system 25 in the embodiment shown in FIG. 3 comprises a centrally mounted camera 21 located approximately at the forehead of the wearer in use. In this manner, the camera 21 is ideally suited for capturing frontal imagery of the wearer in use. Furthermore, adjacent the camera 21 may be located the lights 23. The lights 23 may be suited for illumination and status indication purposes. In this manner, in the embodiment shown, the lights 23 may comprise one or more high-intensity LED devices for illumination purposes and one or more RGB LED lights for status indication purposes.

Furthermore, the helmet system 25 comprises an adjustable tightness mechanism 31 for adjusting the tightness of the helmet system 25 in use. In this regard, the adjustable tightness mechanism 31 expands and contracts in accordance with the actuation of the strap buckle by the user.

Continuing with FIG. 3, there is shown a magnified view of a cross-section of the helmet system 25, especially showing PCB module 32. There will be described in further detail below the mounting of the PCB module 32 beneath the outer shell 27 of the helmet system 25 in a safe manner, such that, in the event of impact, the PCB module 32 does not penetrate or bear against the skull of the wearer or otherwise compromise the structural integrity of the helmet system 25.

In FIG. 3 the magnified cross-sectional view of the helmet system 25 especially shows the rearward location of the battery module 40 comprising a battery 33. Again, there will be described in further detail below, the containment of the battery 33 in a manner that seeks to reduce additional damage to the user.

Turning back to FIG. 1, there is shown a view of the leading edge of the helmet system 25, especially showing the camera 21. As will be described in further detail below, in embodiments shown, the camera mount is in the form of a crash protection module 10 which is adapted to compress from a standby configuration to a compressed nonoperational configuration during a camera impact. In this manner, a forward orientated impact will not necessarily drive the camera 21 towards the skull of the wearer in use.

The crash protection module 10 is designed to be associated with the wearable armour, which may be other kinds of armour, including thigh guards, forearm protectors, gloves, boots, shin guards, chest plates, but in the embodiments shown is a helmet system 25. The crash protection module 10 includes a deflector element 11 which is associated with the wearable armour such that any impact energy received by the crash protection module 10 is deflected in a direction parallel with a skin (the shell 27 in the embodiment shown of the wearable armour (that is, at a tangent to the skin at that particular point of impact). In practice in one embodiment the association with the wearable armour is a mounting in one or more recesses of the wearable armour, and in one embodiment there are elements of the crash protection module which cooperate with selected recess elements of the wearable armour (the helmet system 25) in a way which is herein described.

In one embodiment there are provided and shown a plurality of energy absorbing elements 12 mounted on an element mounting base 13, each one of the plurality of energy absorbing elements 12 including a compressible element 14, being further configured in the event of an impact to compress generally along a longitudinal axis. Each one of the plurality of compressible elements 14 is adapted to be received in one or more cooperating recesses 15 of a substrate of compressible armour material 30, also described herein as the outer core 30.

The crash protection module 10 for mounting on wearable armour may include one or more of the compressible elements 12 mounted or designed on the wearable armour in such a way as to deflect the crash protection module 10 during an impact so as to facilitate deflection of impact forces away from a perpendicular to the wearable armour 25 and toward an axis parallel to a skin 27 (at a tangent at that particular point of impact) of the wearable armour. The mounting or design of the compressible elements to facilitate deflection may include various mechanisms within its scope, including a variation of density of each compressible element, by constructing each one from a different material for adjacent compressible elements, or varying the density by providing more dense versions of the same material, or providing voids within each compressible element, or arranging each compressible element on the base 13 so that there are more of them in one particular area, so as to provide a weakness on one side of the base, facilitating impact energy to flow in that direction. It can be seen that suitable arrangements can be found within the scope of the disclosure, and in another embodiment, there is a deflector plate 16 provided which is the actual base 13, or is formed from a distinct plate 17 made from another material that is attached to the base. The deflector plate 16 may be a wedge shaped element to facilitate deflection of the impact forces along the skin 27 and into the core 30. The deflector plate 16 may be steel, plastic, or some other relatively hard material.

It may be that impact forces are absorbed by the compressible elements 12 and no deflection is conducted. In that instance, the impact forces are dissipated by the compressing of the compressible elements 12 and some may be transferred sideways along the skin 27 anyway, and into the core 30 due to sideways expansion of the compressible elements 12 during compression.

The arrangement of the crash protection module 10 is such that during an impact, the crash protection module 10 tends to absorb and deflect impact forces in a direction toward the skin 27 of the wearable armour and into an energy absorbing layer of compressible armour material 30 lined along the skin 27 of the wearable armour (helmet 25).

The base 13 is attached to the or each compressible element 12 for ease of module assembly and for efficient transfer of forces to the base 13 and/or the deflector element. In another embodiment the base is integral with the or each compressible element wherein the base is constructed from the same material as the compressible element for further ease of module assembly and more efficient transfer of forces to the base and/or the deflector element.

In one embodiment the deflector element or deflector plate 16 is integral with one or more of the compressible elements in that the deflector element 16 is an arrangement of compressible elements mounted on a deflecting base, wherein each of the compressible elements has a slightly different compressibility to facilitate deflecting of the deflecting base in the event of an impact on a portion of the crash protection module 10.

The deflector element 16 may be constructed from a hard plastic or any suitable material and may be a wedge or ramp which is mounted on the element mounting base or the element mounting base itself of course may be a ramped or wedge-shaped deflector element so that it may facilitate deflecting impact forces in the event of an impact.

The or each compressible element 12 may be constructed from a suitable compressible material including rubber, expanded polystyrene (EPS), and other suitable materials. The or each compressible element may also include one or more voids of a separate material of a different density such as rubber, expanded polystyrene, air, and the like so as to facilitate deflection and compression without rupturing or distending an inside skin of the wearable armour. Advantageous densities of the rubber elements in computer modelling crash testing (in Ansys) has been found to be between about 500 kg/m³ and 3000 kg/m³, although, as it will be understood, suitable densities could be 750, 1000, 1250, 1500, 1750, 2000, 2250 and the like, depending on the size of the wearer's head, mass, application, etc. The density of the EPS elements is between about 25 kg/m³ and 200 kg/m³ and for similar reasons the density of the EPS elements could be 40, 50, 55, 60, 65, 70, 75, 80, 85, 90, 110, 125, 150 etc. Results of the Ansys modelling indicates that the crash protection module 10 dissipates impact forces so that the camera element 21 does not worsen impacts by necessary removal of certain compressible foam from its mounting zone.

The arrangement of compressible elements 12 may be such that the they are mounted on the base in a staggered arrangement, so that they are evenly spaced from each of their neighbouring compressible elements.

Generally speaking, in an arrangement, the compressible elements 12 are roughly arranged in diagonal rows of three across a rectangular base plate, itself arranged on a wedged deflector plate. The camera 21 is mounted on the deflector plate, which faces outward from the user.

The wearable armour may include gloves, boots, shin guards, forearm or upper arm guards, thigh guards, breastplate or any suitable wearable armour. In one particularly suitable embodiment the wearable armour is a helmet for bicycle riding, skiing, snowboarding, motorcycle riding, car racing, or other suitable head protection for sports and other active pursuits.

The arrangement may be such that a skin of the wearable body armour (helmet system 25 in the embodiment shown) may comprise a plurality of crash protection modules 10 disposed abutting, adjacent or near enough to one another, so as to form a kind of articulated tiled or articulated plate exoskeleton, each tile or plate of which may perform its compressing and/or deflection function in the event of a crash. In that embodiment, the impacted area may be replaced after a crash and then a user may then proceed to keep wearing the wearable body armour. In one advantageous embodiment shown in the Figures, one crash protection module forms one portion of the wearable armour at a front portion of the helmet system 25, and on the crash protection module is mounted the camera 21, the purpose of the crash protection module 10 being to protect the user from the camera 21 impacting their head in an accident.

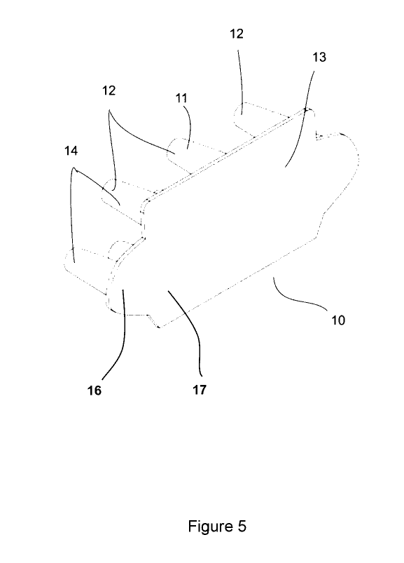

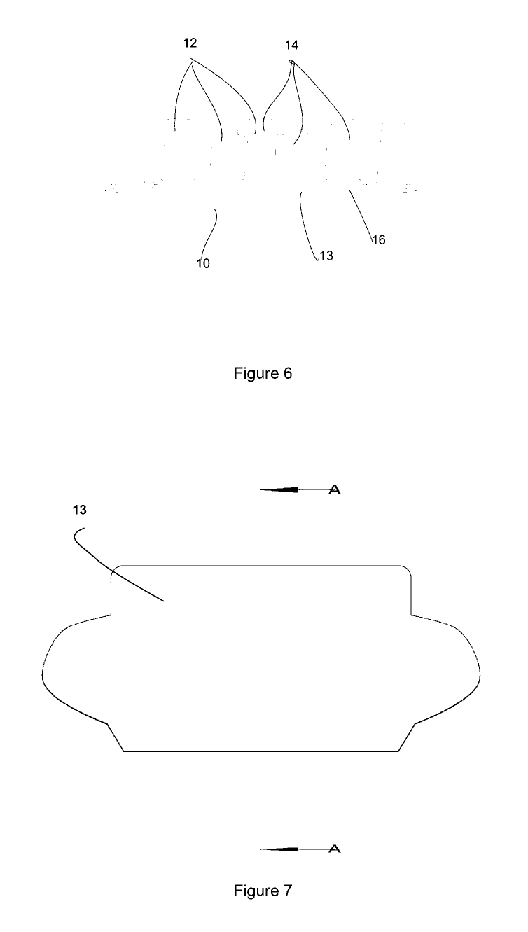

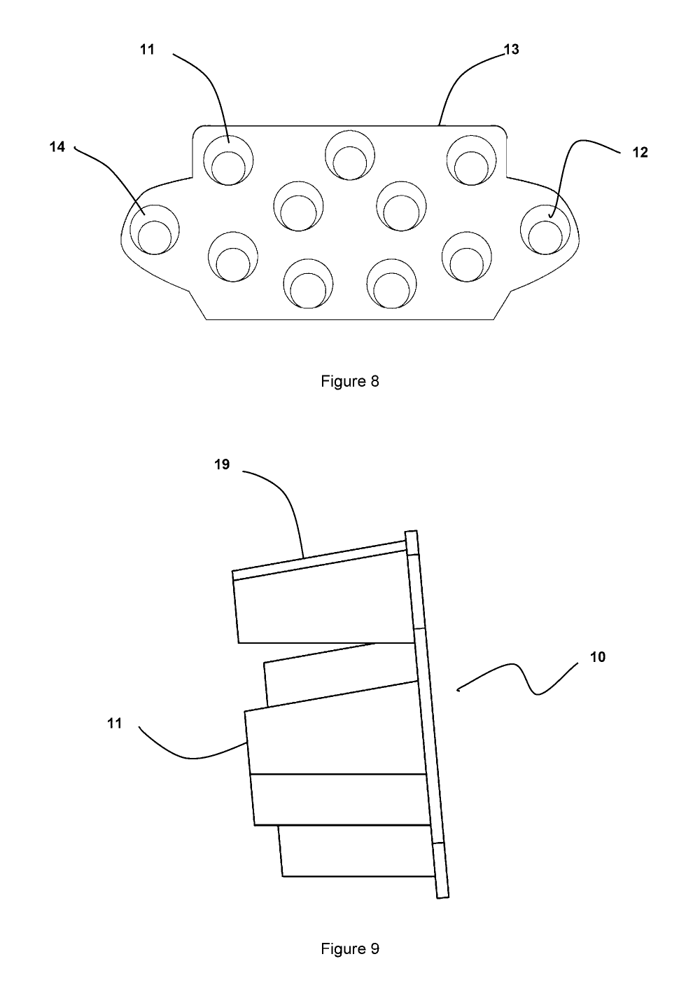

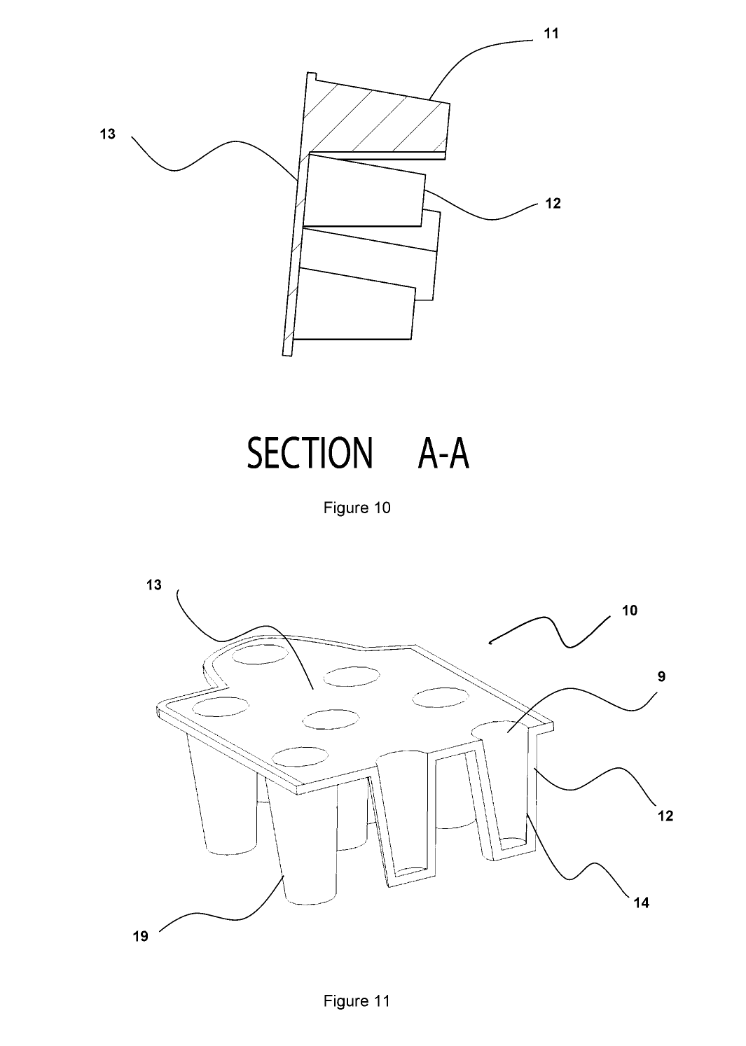

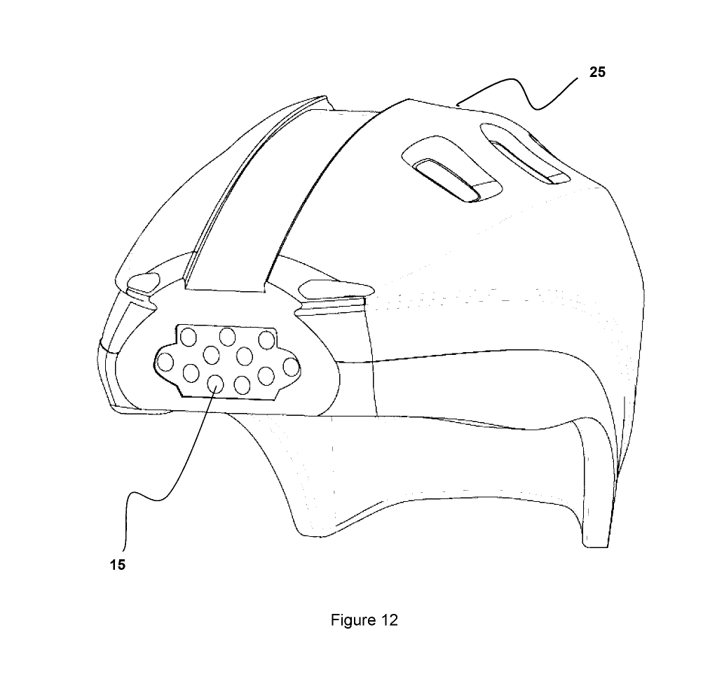

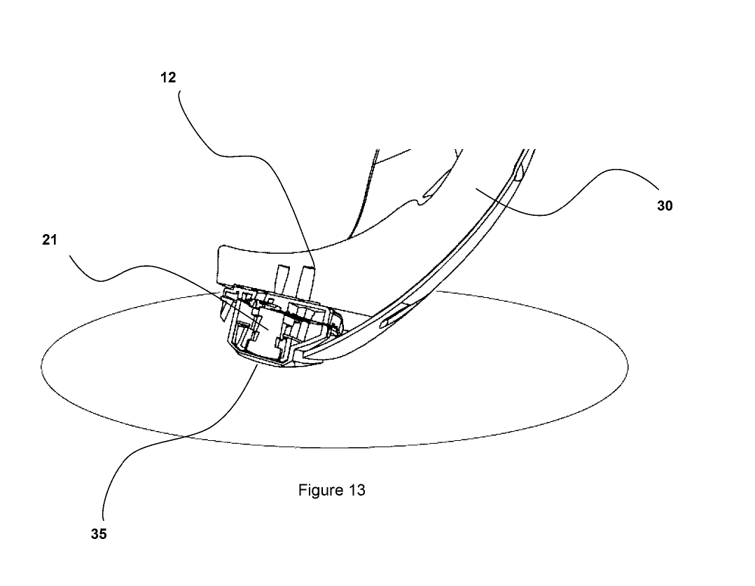

In one embodiment the energy absorbing elements include fingers 19 which when installed in the wearable body armour extend along a longitudinal axis disposed generally perpendicular to the skin of the wearable body armour. The fingers are generally cylindrical and frusto-conical as shown in FIGS. 5 to 18, or may be square in cross section, or any other suitable cross section, including pentagonal, hexagonal, elliptical, or some other irregular cross sectional arrangement. The fingers 19 may form a frusto conical shape and/or may be domed at their ends, or pointed or some other suitable arrangement, depending on the compressibility profile and integration desired with the cooperating recesses in the wearable body armour.

A plurality of voids 9 in the energy absorbing elements may be disposed at the base of each finger or arranged at various intervals along the fingers depending on the compressible profiles that are desired. The or each one of the plurality of voids 9 may be conical, frusto-conical, spherical and any suitable arrangement for controlled collapse of the fingers 19. In one embodiment the arrangement of the voids results in a hollow finger having a wall of 2 mm thickness. In other embodiments the arrangement of the plurality of voids (one for each finger) is such that there is a tapering void, commencing with a 2 mm wall thickness finger and the wall thickness of the finger gradually increasing such that the tapered void is a blind conical void ending about half way along the finger. Other suitable arrangements are contemplated, including that the void extends to 50%, 60%, 70%, 80%, 90% or 95% along the finger, either tapering, or following the finger to form a uniform wall thickness therealong.

Furthermore, there is shown substantially elongate strap accommodation 38 adapted to accommodate the strap of a pair of goggles or the like in use. The strap accommodation 38 is fastened to the outer shell 27 by an upwardly located hinge and releasably fastened to the outer shell 27 by a downwardly located clip mechanism. In this manner, in use, the wearer would pivot the strap accommodation 38 upwards, place the strap of the goggles beneath the strap accommodation 38 and then pivot the strap accommodation downwards 38 for fastening. In embodiments, the strap accommodation 38 also selectively exposes a USB interface 39 beneath the lower end of the strap accommodation 38 so as to advantageously cover the USB interface 39 when the helmet system 25 is in use.

Turning back to FIG. 1, there is shown a top perspective view of the helmet system 25 especially showing the location of the battery module 40 and the air vents 28. Furthermore, the approximate location of the above-mentioned PCB module 32 is shown in silhouette. As will be described in further detail below, the PCB module 32 is adapted for location beneath the outer shell 27 wherein, conversely, the battery module 40 is adapted for location above the outer shell 27 for reasons including firewalling. The location of the camera 21 is also shown.

Turning back to FIG. 1, there is shown a top perspective view of the helmet system 25. Specifically, there is shown the mechanical buttons of the user interface 26 comprising a recording control button 42 and a light control button 43. As will be described in further detail below, the record control button 42 is adapted to control the recording of image and video data by the camera 21 in use.

Furthermore, the light control button 43 is adapted to control the operation of the lights 23.

In embodiments, the activation of the recording control button 42 may actuate the recording of video data by the camera 21. Furthermore, while recording, a double tap of the recording control button 42 may record a waypoint or marker within the video for assisting subsequent review.

Furthermore, the iterative activation of the like control button 43 may cause the light 23 to emit varying light intensities, such as a low beam and a subsequent high beam.

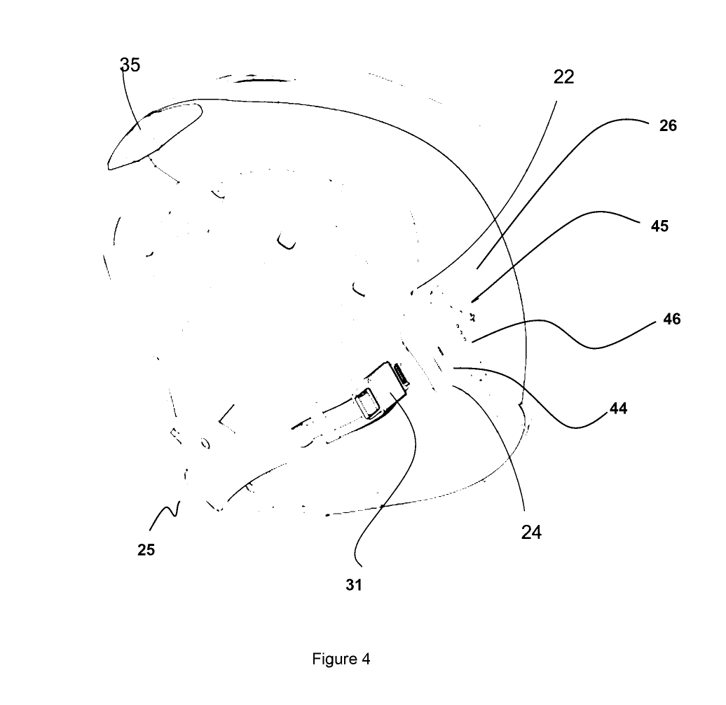

Similarly, in FIG. 4, there is shown a bottom perspective view of the helmet system 25. In this figure, there is shown the user interface 26 comprising a volume up button 45, a volume down button 44 and a communication/music control button 46. The operational functionality of these buttons will be described in further detail below.

In an embodiment, the buttons of the user interface 26 are mechanical push type buttons comprising an ergonomic and weatherproof rubberised overlay.

### Functionality

Having described the above general construction, componentry and functionality of the helmet system 25, there will now be described specific functionality of the helmet system 25 in accordance with preferred embodiments. It should be noted that these embodiments are exemplary only and that accordingly no technical limitation should necessarily be imputed to the embodiments described herein.

### Electronic Housing to Distribute Force

There will now be described particular construction aspects of the helmet system 25 adapted to allow for the accommodation of electronic housing without jeopardising the safety of the wearer or the integrity of the helmet system 25.

Specifically, a problem experienced with existing helmet systems through the incorporation of electronic devices is the danger posed by such electronic devices which may penetrate the skull of the wearer during impact or otherwise compromise the integrity of the helmet. As such, and as will be described in further detail below, the various electronic componentry of the helmet system 25 is arranged and constructed so as to overcome or at least ameliorate these problems.

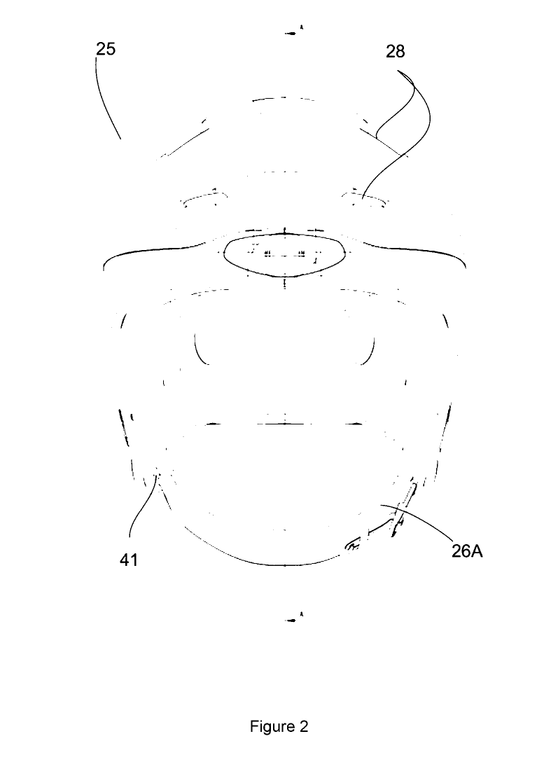

Specifically, referring to FIG. 2, and as alluded to above, in an embodiment, the helmet system 25 comprises a forward located camera module 21 and a rearward located battery module 40 and camera control/PCB system 32. In this manner, the PCB module 32 may comprise a processor, memory device and various peripherals, such as a solid-state acceleration sensor, orientation sensor and location sensor and other components.

It should be noted that the locations of the PCB module 32, battery module 40 and camera 21 may be varied within the purposive scope of the embodiments described herein. For example, the PCB module 32 may be located at the present location of the battery module 40 and the battery module 40 located at the rearward vertical portion of the helmet system 25. However, the location of the PCB module 32 and the battery module 40 reduces the exposure of the PCB module 32 and the battery module 40 from lateral forces typically experience when falling, such as when the wearer falls backwards and hits the back of the helmet system 25. In this manner, generally the PCB module 32 and battery module 40 would experience force only from a downwardly oriented force to the upper surface of the helmet system.

In an embodiment, the PCB module 32 and the battery module 40 are modular units, so as to allow for the replacement, such as once damaged, or for upgrade and the like. In this embodiment, the PCB module 32 and the battery module 40 are located within a respective receptacles or cradles so as to allow for their selective removal.

Turning now to FIG. 3, there is shown the mounting configuration of the PCB module 32 in further detail. As is apparent from FIG. 3, the PCB is adapted for location beneath the outer shell 27 whereas the battery module 40 as will be described in further detail below is located above the outer shell 27. Specifically now, the PCB module 32 comprises planar PCB 51 upon which the various electronic componentry is soldered.

The PCB module 32 is located beneath the outer shell. As is also apparent, by the inner underside of the PCB housing being substantially planar and the inner underside of the PCB being substantially curved, there is provided an airgap 52 between the PCB 51 and the outer shell 27. The airgap 52 allows for slight flexing of the outer shell 27 without substantially compressing the components of the PCB 51.

For replacement of the PCB module 32, the outer shell 27 would be removed by disengaging the above-mentioned cleats 48.

In an embodiment, the PCB module 32 comprises an external PCB housing. The PCB housing provides protection for the PCB 51 such as by way of shock absorbing properties, thermal insulation properties and electrical installation properties. In this regard, referring to figure, there is shown a perspective view of the PCB housing in further detail. As is apparent, the PCB housing comprises lateral openings to allow for the connection of data cables. In an embodiment, the data cables are high-speed digital data cables adapted for the high-speed transmission of data including audio and video data.

In an embodiment, the PCB module 32 may be provided with the data cables or alternatively comprise connections to which the data cables may be connected during installation.

Now, referring again to FIG. 3, in an embodiment, the helmet system 25 further comprises a barrier 54 adapted to interface between the outer core 30 and the PCB module 32, the barrier 54 being located between the outer shell 27.

The provision of the barrier 54 substantially prevents any portion of the PCB module 32 such as the PCB board 51 from penetrating beyond the barrier 54. As such, during the event of an impact, the PCB module 32 would be sacrificial so as to adequately protect the skull of the wearer.

The barrier 54 may be made from any suitable material to provide the necessary resilience but is typically manufactured from a hardened plastic layer of the like which may be vacuum formed and adhered to the outer core 30.

The arrangement of the PCB module 32 as shown in FIG. 3 does not present sharp edges which may penetrate the layers between the PCB module 32 and the skull (not shown) of the wearer. In other words, the underside of the PCB module 32 is substantially flat so as to provide an even distribution of force onto the barrier 54 and therefore the subsequent outer core 30 and inner padding 29.

In the embodiment shown in FIG. 3, the helmet system 25 may further comprise an inner lining 29A for comfort purposes, such as by comprising sweat wicking or breathability properties, for example.

In an embodiment, the PCB module 32 may simply be held in place by the outer shell 27.

However, in other embodiments, the PCB housing may be secured within the PCB housing receptacle by way of suitable mechanical fastener, such as click-in fasteners, tabs and the like.

The location of the battery module 40 above the outer shell 27 advantageously allows for the swift replacement of the battery 33 when required, such as once the battery 33 has become depleted and a fresh battery 33 is on hand. Furthermore, the location of the battery 33 above the outer shell 27 provides firewalling advantages wherein, for example, should a short occur or the battery otherwise fail and create excessive heat or spontaneously burst into flame, the heat and/or flame would be contained above the outer shell 27.

Furthermore, the containment of the battery 33 above the outer shell 27 further protects the inner layers of the helmet system 25 from potentially corrosive chemicals which may leak and compromise the integrity of the helmet system 25 in an unnoticeable manner.

In an embodiment, the battery 33 is a lightweight battery, such as a lithium battery.

Furthermore, for impact resilience, the battery 33 is preferably a lithium polymer battery which exhibits superior properties when crushed such as by not spontaneously combusting, leaking corrosive material and the like.

In a similar fashion as for the PCB module 32, the battery module 40 may be housed within a battery housing. In an embodiment, the battery housing may be similarly strengthened, especially by comprising a polycarbonate upper layer 27 to complement the remainder of the outer shell 27 of the helmet system 25. In an embodiment, the battery module 40 may further comprise cushioning between the battery housing and the battery.

Furthermore, the battery module 40 may further comprise appropriate electrical contacts to allow for the making of an electrical circuit once the battery module 40 is engaged within the battery receptacle.

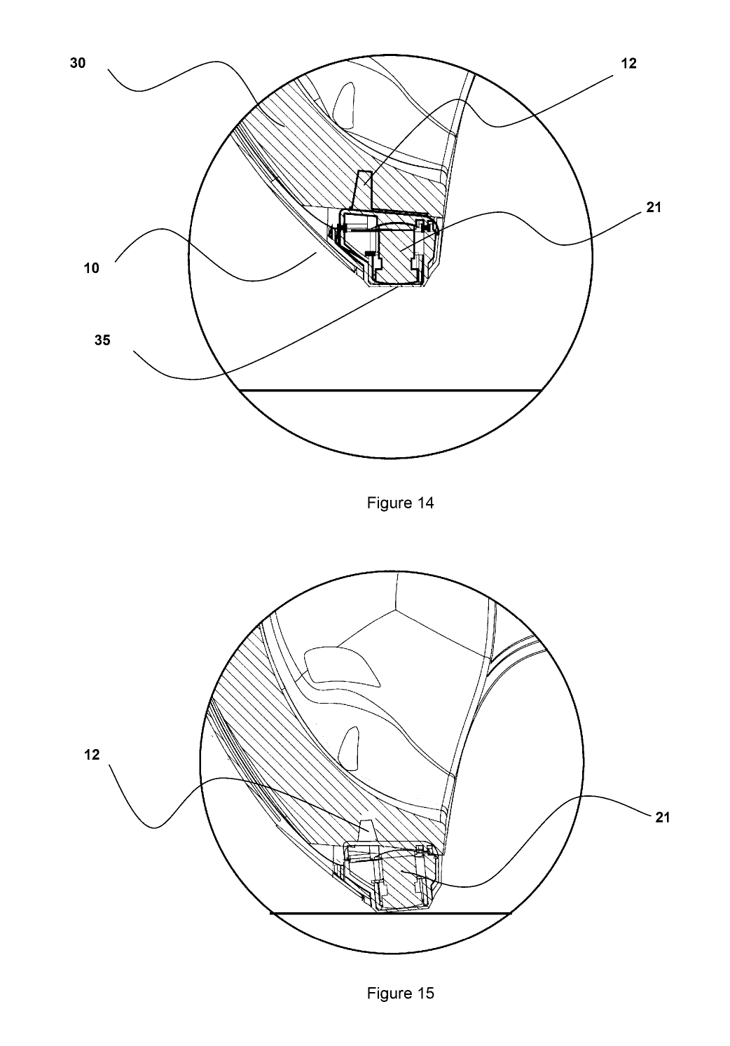

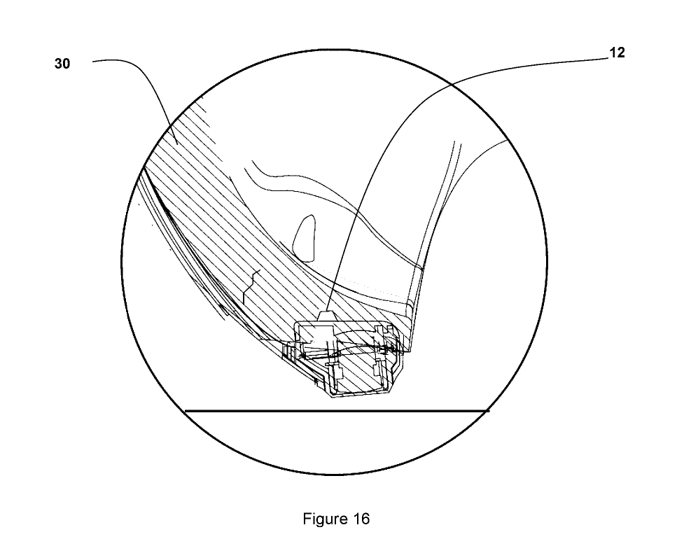

Turning now to FIGS. 14 to 16, there is shown cross-sectional detail views of the camera 21 in further detail to exemplify the impact force accommodation of the camera 21. As is apparent, the camera 21 is accommodated behind a lens 35. As is shown in the embodiment, the camera 21 is mounted on a crash protection module 10 which is able to transition from an extended operational configuration shown in FIG. 14 to a compressed non-operational configuration shown in FIGS. 15 and 16. In this manner, under extreme impact force, the energy absorbing elements 12 collapses rather than piercing the core 30 of the helmet system 25 in one or more ways as herein described.

It will be appreciated by persons skilled in the art that numerous variations and/or modifications may be made to the technology as shown in the specific embodiments without departing from the spirit or scope of technology as broadly described. The present embodiments are, therefore, to be considered in all respects as illustrative and not restrictive.

1. A crash protection module for mounting on wearable armour, the crash protection module comprising:
a mounting base adapted to receive an external device;
an energy absorbing element on the mounting base, the energy absorbing element configured to compress generally along a longitudinal axis on impact;
wherein the energy absorbing element is adapted to be received in a cooperating recess of wearable armour.

2. The crash protection module according to claim 1 comprising a plurality of energy absorbing elements adapted to be received in a cooperating recesses of the wearable armour.

3. The crash protection module according to claim 1 or 2 wherein the mounting base is integral with the energy absorbing element.

4. The crash protection module according to any one of claims 1 to 3 wherein the energy absorbing element is cylindrical, square, pentagonal, hexagonal, elliptical, or irregular in cross section.

5. The crash protection module according to any one of claims 1 to 4 wherein the external device is integral with the mounting base.

6. The crash protection module according to any one of claims 2 to 5 wherein the plurality of energy absorbing elements each have a slightly different compressibility to facilitate deflecting of the mounting base in the event of an impact on a portion of the crash protection module.

7. The crash protection module according to any one of claims 1 to 6 wherein the energy absorbing element is constructed from a compressible material selected from the group consisting of rubber and expanded polystyrene (EPS).

8. The crash protection module according to any one of claims 1 to 7 wherein the energy absorbing element includes one or more voids of a separate material of a different density.

9. The crash protection module according to claim 7 or 8 wherein the density of the rubber is between about 500 kg/m³ and 3000 kg/m³.

10. The crash protection module according to claim 7 or 8 wherein the density of the EPS is between about 25 kg/m³ and 200 kg/m³.

11. The crash protection module according to any one of claims 1 to 10 wherein the energy absorbing element is arranged on the mounting base in a staggered arrangement being evenly spaced from each of their neighbouring energy absorbing elements.

12. The crash protection module according to claim 11 wherein the energy absorbing element is arranged in diagonal rows of three across a rectangular mounting base.

13. An article of wearable armour adapted to receive an external device, the amour comprising:
an impact resistant shell;
a cooperating recess in the impact resistant shell adapted to receive an energy absorbing element; and
a crash protection module according to any one of claims 1 to 12.

14. The article of wearable armour according to claim 14 further including an external device attached to the crash protection module.

15. The article of wearable armour according to claim 15 wherein the external device is selected from the group consisting of light, camera, and phone.

16. The article of wearable armour according to any one of claims 13 to 15 selected from the group consisting of helmet, glove, boot, shin guard, forearm or upper arm guard, thigh guard, and breastplate.

17. The article of wearable armour according to claim 16 wherein the helmet is for bicycle riding, skiing, snowboarding, motorcycle riding, or car racing.

18. The article of wearable armour according to claim 17 wherein the helmet is for bicycle riding.

19. The article of wearable armour according to any one of claims 13 to 18 wherein the crash protection module is flush mounted within the wearable armour.

20. A helmet comprising:
an impact resistant shell;
a crash protection module including a plurality of energy absorbing elements;
cooperating recesses in the impact resistant shell adapted to receive the plurality of energy absorbing elements; and
a camera mounted in the crash protection module.
